(19) United States
(12) Patent Application Publication
(10) Pub. No.: US 2014/0267018 A1
(43) Pub. Date: Sep. 18, 2014

(54) SYSTEM AND METHOD OF GESTURE INTERPRETATION BY BODY PART TRACKING

(71) Applicant: UMOOVE SERVICES LTD., Jerusalem (IL)

(72) Inventor: Yitzchak KEMPINSKI, Geva Binyamin (IL)

(73) Assignee: UMOOVE SERVICES LTD., Jerusalem (IL)

(21) Appl. No.: 14/203,626

(22) Filed: Mar. 11, 2014

Related U.S. Application Data
(60) Provisional application No. 61/776,874, filed on Mar. 12, 2013.

(51) Int. Cl. G06F 3/01

(52) U.S. Cl. CPC G06F 3/017
USPC 345/156

(57) ABSTRACT

A system and method of using an imager to capture a series of images of a body part, of using a processor to interpret a gesture or movement(s) of the body part that is detected in the series of images as an instruction to a processor to execute a function on a device. The detected movement may interpreted as insignificant or unintended and may be discounted as unintended noise or otherwise ignored.

### CROSS-REFERENCE TO RELATED APPLICATIONS

This application is claims benefit from U.S. Provisional Patent Application No. 61/776,874, filed Mar. 12, 2013, which is hereby incorporated by reference.

### BACKGROUND

Tracking of a movement of one or more body parts such as a head, eye, or other parts may be performed by analysis of a series of images captured by an imager and detection of a movement of one or more of such body parts. Such tracking may activate one or more functions of a device or other functions.

### EMBODIMENTS OF THE INVENTION

Embodiments of the invention may assign particular meanings to gestures or motions or movements of a body part that are detected in a series of frames. The detection of movements constituting the gestures may be done through for example a tracking of a movement of a head, eye(s), eyelid, eyebrow or other body part over several frames that are captured by an imager.

FIG. 1 shows a user of an electronic device that detects a motion of a head or body part, compares the detected motion to patterns of motions that are stored or associated with the device, and executes a function that is associated with the pattern that is positively compared with the detected motion or movement.

In some embodiments, samples of gestures of a body part may be recorded or otherwise stored in a memory of a device, and such gestures may be assigned or associated with particular functions to be executed. Such samples may be recorded in patterns of movements by an individual user, such as part of a training or learning session during which a processor, memory or other components of an electronic device learns and records movements of a user that constitute gestures. Such recorded gestures may be associated by the user with one or more meanings of functions. Alternatively or in addition, a device may include pre-recorded patterns of movements of eyes, heads, faces, mouths, or other body parts, and such patterns may be associated with functions or meanings that may be applied by a device upon recognition of a pattern in a series of images of a user. A processor or memory of a device may learn or continually or periodically refine the patterns that are detected and associated with one or more particular functions, by recording further detected motions and the associations with functions that are requested or indicated by the user.

For example, a gesture may be recorded as a pattern of movements of a head in a series of frames that shows a head rising (either in an absolute pixels distance or for example as an angle relative to a starting point). A speed, a measure of a continuity of a flow of motion of the rising head, a position of a rest or stopping of the motion of the head, a duration in time of the movement of the head from start to finish or within a number of frames, and a distance or extent of the movement of the head in such motion may also be measured. In some embodiments, certain detected motions may be ignored or not included in a calculation or determination of a gesture. For example, if a system is expecting an up/down motion, then a side to side motion may be ignored or not included in a calculation or determination of a gesture. The motion that is ignored or not included in a calculation or determination of a gesture as being not expected may be interpreted as an indication that the user being tracked is not responding to a query or is not intending to make the expected gesture. The unexpected motion may also be interpreted as insignificant or unintended and may be discounted as unintended noise or otherwise ignored, for example based on the length or duration of the unexpected movement as is compared with the duration of the expected gesture. One or more of such parameters of detected motion may be compared to stored parameters, and a match of detected parameters to stored parameters may be made. Upon finding of such a match, a processor may implement a function or instruction that is associated with the matched gesture. In the example of detection of a rising head, an instruction to scroll up a view of a screen may be implemented by a processor on for example a hand held device or other electronic device. Detection of a lowering of a head may be detected and implemented as a scroll down instruction. A sideways nod may be implemented as a “no” instruction, and an up and down nod may be implemented as a “yes” or affirmative instruction. Other gestures and programmed or associated functions are possible. For example, a yes no gesture may be defined as up-down, as up-down-up, as down-up-down or otherwise as may accommodate gestures used in particular cultures or by particular people.

In some embodiments, an interpretation of a detected gesture may be dependent on a prompt or other circumstance that may be presented to a user, or that may be expected by a processor or device. For example, a user may be presented with a query such as “Do you want to save this file”. In such case, a nod that may include a raising of a head may be interpreted as an affirmative instruction rather than as an instruction to scroll. In this way, a same or similar detected gesture may be implemented in varying ways, depending on the context presented to the user or faced by the device. Continuing the above example, a raising of a head by a user may be interpreted as a scroll up instruction if a screen view presented to a user includes a continuation portion that could be scrolled up.

Other gestures that may be stored, detected and interpreted include a squint, an opening of eyes widely, as may be associated with an instruction to enlarge, shrink or otherwise change a view appearing on a screen. In another example, a swipe of a head may be programmed to be interpreted as a dragging open of a menu or of some other item that is hidden in a screen, or may be programmed to be interpreted as a gesture to push something off of a screen. A toss of a head may be programmed to be interpreted as a gesture to throw away something from a screen or have it fly off of a view of a screen. In some embodiments a sideways or up-and-down movement of a head may be programmed to be interpreted as a page turning instruction. In some embodiments a movement of a head (such as a swipe to the side or up down) or eyes may be programmed to select an item, highlight an item, to select a row in a list, to select a row which is currently highlighted in a list/menu, to drag of a text or to take some other action. In some embodiments a slight clockwise rotation of a head may cause a rotation of a view or element on a screen, clockwise or counterclockwise. Other motions that may be stored and associated with instructions include a look left, a look right, a hair flip and others.

1. A system in accordance with the specification and drawings.

2. A method in accordance with the specification and drawings.
